(19) United States
(12) Patent Application Publication
(10) Pub. No.: US 2022/0396147 A1
(43) Pub. Date: Dec. 15, 2022

(54) METHOD AND APPARATUS FOR CONTROLLING A PERSONAL MOBILITY VEHICLE BASED ON CONGESTION

(71) Applicants: HYUNDAI MOTOR COMPANY, Seoul (KR); KIA CORPORATION, Seoul (KR); KOOKMIN UNIVERSITY INDUSTRY ACADEMY COOPERATION FOUNDATION, Seoul (KR)

(72) Inventors: Gu Min Jeong, Seoul (KR); Hyun Jung Oh, Seoul (KR); Seung Hyeon Lee, Seoul (KR); Yo Cheol Jang, Suwon-si (KR); Choong Yub Lee, Seoul (KR); Jae Jun Ha, Hwaseong-si (KR)

(21) Appl. No.: 17/520,993

(22) Filed: Nov. 8, 2021

(30) Foreign Application Priority Data
Jun. 11, 2021 (KR) 10-2021-0076191

(51) Int. Cl. B60K 31/00; G06K 9/00; G06T 7/20; G01C 21/36

(52) U.S. Cl. CPC B60K 31/0008; G06K 9/00778; G06K 9/00362; G06T 7/20; G01C 21/3691; G06T 2207/30242; G06T 2207/30232; B60K 2031/0016

(57) ABSTRACT

A method and an apparatus for controlling personal mobility device (PMD) depending on congestion includes identifying a target area according to an expected route of the PMD, acquiring a degree of congestion of the target area based on at least one of a type of objects, a movement of the objects, a distance between objects, the number of objects that is expected, and a speed limit of the target area, and controlling speed of the PMD according to the degree of congestion.

### CROSS REFERENCE TO RELATED APPLICATIONS

This application is based on, and claims priority to, Korean Patent Application Number 10-2021-0076191 filed on Jun. 11, 2021, the disclosure of which is incorporated by reference herein in its entirety.

### TECHNICAL FIELD

The present disclosure in some embodiments relates to a method and device for controlling a personal mobility device (PMD) according to a degree of congestion which set a target area in an expected route of a PMD, which is the PMD, calculate the degree of congestion according to characteristics of objects in the target area, and control the PMD according to the degree of congestion.

### BACKGROUND

The statements in this section merely provide background information related to the present disclosure and do not necessarily constitute prior art.

In recent years, the importance of cars as transportation is decreasing, and the importance of personal mobility devices (PMDs) is increasing. Here, the PMD is a movable object for few people. For example, an electric kickboard, a bike, etc.

Unlike a car, a PMD can travel on roads that are not built for cars. For example, cars can only travel on a roads built for cars, while the PMD can travel on bicycle lanes or sidewalks. That is, the PMD traveling on various roads has a higher risk of colliding with a pedestrian.

Mobility of the PMD is better than that of cars on roads that are not built for cars. For example, on narrow roads, it is difficult for cars to travel at a high speed or make sharp turns. Meanwhile, since the PMD is smaller in size, it is easier for PMDs to travel at a higher speed or make sharp turns on narrow roads.

Certain driving characteristics of the PMD makes it easier to collide with pedestrians or other PMDs. In particular, when roads are crowded with pedestrians and PMDs, a passenger on the PMD has a very high risk of colliding with pedestrians or other PMDs.

Therefore, researches to prevent collision with pedestrians and other PMDs are much needed.

### SUMMARY

There is provided a control method of a personal mobility device (PMD) depending on congestion, comprising identifying a target area according to an expected route of the PMD, acquiring a degree of congestion of the target area based on at least one of a type of objects, a movement of the objects, a distance between objects, the number of objects that is expected, and a speed limit of the target area, and controlling speed of the PMD according to the degree of congestion.

There is provided a control device for a personal mobility device (PMD) performing control depending on congestion, comprising a target area identification unit that identifies a target area according to an expected route of the PMD, a congestion degree acquisition unit that acquires a degree of congestion of the target area based on at least one of a type of objects in the target area, a movement of objects, a distance between objects, the number of objects that is expected, and a speed limit of the target area, and a control unit that controls the speed of the PMD according the degree of congestion.

### BRIEF DESCRIPTION OF THE FIGURES

FIG. 1 is a diagram illustrating components of a PMD in accordance with an embodiment of the present disclosure.

FIG. 2 is a diagram illustrating a control operation of a PMD in consideration of degree of congestion in accordance with an embodiment of the present disclosure.

FIGS. 3A and 3B are diagrams illustrating a control operation of a PMD in consideration of degree of congestion in accordance with an embodiment of the disclosure.

FIG. 4 is a flowchart illustrating a control step of the PMD in accordance with an embodiment of the present disclosure.

FIG. 5 is a flowchart illustrating a specific control procedure of the PMD in accordance with an embodiment of the present disclosure.

### DETAILED DESCRIPTION

Hereinafter, some embodiments of the present disclosure are described with reference to the drawings. It should be noted that in giving reference numerals to components of the accompanying drawings, the same or equivalent components are denoted by the same reference numerals even when the components are illustrated in different drawings. In describing the present disclosure, when determined that a detailed description of related known functions or configurations may obscure the subject matter of the present disclosure, the detailed description thereof has been omitted.

In addition, in describing the components of the present disclosure, terms such as first, second, A, B, (a), (b), etc. may be used. These terms are used only in order to distinguish any component from other components, and features, sequences, or the like, of corresponding components are not limited by these terms. Throughout the present specification, unless explicitly described to the contrary, “including” and “comprising” any components should be understood to imply the inclusion of other elements rather than the exclusion of any other elements. A term, such as “part,” “module,” or the like described in the specification, means a unit of processing at least one function or operation and may be implemented as hardware or software or a combination of hardware and software. When a component, device, element, or the like of the present disclosure is described as having a purpose or performing an operation, function, or the like, the component, device, or element should be considered herein as being “configured to” meet that purpose or to perform that operation or function.

In the following, a personal mobility device (hereinafter ‘PMD’) is a movable object or a personal transporter. For example, types of the PMD include personal mobility vehicle (PM vehicle), micro mobility vehicle, electric bicycle, electric kickboard, electric scooter, electric wheelchair, electric bike, 2-wheel drive, smart car, shuttle, personal movement means, personal flight means, smart mobility, shared mobility, First Mile, Last Mile, PAV (Purpose Built Vehicle), PAV (Personal Air Vehicle), car, electric car, motor vehicle, passenger automobile, alternative fuel vehicle and etc.

Intelligent Transport System (ITS) includes a road side unit (RSU) or a mobile communication station. The road side unit or the station may all perform broadcasting, and may support communication methods such as unicast, multicast or the like if necessary. In the following, road side units (RSUs) are described with reference to performing Vehicle to Everything (V2X) communication with a PMD. The V2X communication includes LTE-V2X, C-V2X, 5G-V2X, WAVE (Wireless Access In Vehicular Environment), DSRC (Dedicated Short Range Communication), and the like. In addition, communication standards used in Intelligent Transport System (ITS) may be used. In the following, the terms road side unit and station may be used interchangeably.

The control device of the PMD may be implemented as a server located outside the PMD. The control device may also be implemented by a device, a user terminal, or the like located inside the PMD. The control device may in advance store at least one of a virtual map, identification information of the road side unit, a position coordinate corresponding to the identification information, identification information of a PMD, or subscriber information of a passenger. Here, the position coordinate is latitude and longitude or a two-dimensional or three-dimensional coordinate based on a specific point. In the following, the control device is described as being mounted on the PMD.

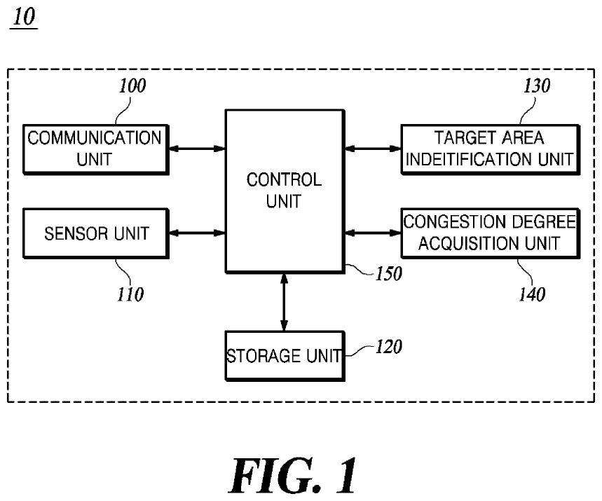

FIG. 1 is a diagram illustrating components of a PMD in accordance with an embodiment of the present disclosure.

Referring to FIG. 1, the control device 10 (hereinafter referred to as “control device”) of the PMD includes a target area identification unit 130, a congestion degree acquisition unit 140, and a control unit 150. The control device 10 may further include the communication unit 100, the sensor unit 110, and the storage unit 120.

The control device 10 may generate an expected route of the PMD through the information collected by the sensor unit 110 or may receive the expected route of the PMD from the communication unit 100. For example, the control device 10 can generate an expected route of the PMD by using the position, speed, direction, route history, acceleration, departure point, destination, or the like of the PMD. The control device 10 may also receive an expected route from an external device or ITS.

The control device 10 may identify a target area along an expected route through the target area identification unit 130. Here, the target area is an area in which the degree of congestion is calculated based on the expected route of the PMD. When the target area is identified by the target area identification unit 130, the control device 10 may collect information about the target area or objects in the target area from the communication unit 100. The target area may preset a specific area in accordance with the passenger.

The communication unit 100 is performs wireless communication with an external device or an intelligent transport system (ITS).

The communication unit 100 can receive information about a target area or objects in the target area from an external device or an ITS. For example, the communication unit 100 may receive an image in a target area captured by a camera of the ITS, or may receive information about objects in the target area processed by a server of the ITS. When an external device calculates the degree of congestion, the communication unit 100 may receive the calculated degree of congestion from the external device. Here, the external device means a server of the ITS or a terminal of the user.

The sensor unit 110 senses objects near the PMD, and collects driving information of the PMD.

The sensor unit 110 may include one or more of a camera, a Lidar sensor, a radar sensor, and a vision sensor. In addition, the sensor unit 110 may further include sensors capable of sensing objects near the PMD. Further, the sensor unit 110 may include sensors for collecting driving information. For example, the sensor unit 110 may include a GPS sensor unit, GPS map, etc.

The storage unit 120 stores information for control of the PMD.

The storage unit 120 may store information collected by the communication unit 100 and the sensor unit 110. When the target area is a preset area, the storage unit 120 may store information about the preset area. In addition, the storage unit 120 may further store information for calculating the degree of congestion.

The target area identification unit 130 identifies a target area in accordance with an expected route of the PMD.

In accordance with an embodiment of the present disclosure, the target area identification unit 130 identifies a preset area according to an expected route of the PMD. For example, in a case where a preset area is set and stored in advance for each road, which the PMD can travel on, and an expected route of the PMD passes the preset area, the target area identification unit 130 can identify the preset area.

In accordance with another embodiment of the present disclosure, the target area identification unit 130 may identify an area determined through object clustering according to an expected route of the PMD. For example, when sensor devices such as a camera, a lidar sensor, and a radar sensor of an ITS recognize and cluster objects in a specific area, the target area identification unit 130 may receive information about the clustered area from the ITS through the communication unit 100, and determine the clustered areas as the target areas. The object clustering may be implemented by a clustering method such as hierarchical clustering, partitioning clustering, k-means clustering.

In accordance with another embodiment of the present disclosure, the target area identification unit 130 may recognize surrounding objects through the sensor unit 110, cluster the recognized objects, and determine the area, where the clustered objects exist, as the target area. The object clustering may be implemented by a clustering method such as hierarchical clustering, partitioning clustering, k-means clustering. From the data collected by the sensor unit 110, information about a target area and an object in the target area may be extracted. The target area identification unit 130 may have a narrower target area identification range but a faster identification speed when identifying a target area through the sensor unit 110 compared to the case when the communication unit 100 identifies the target area.

The control device 10 identifies a target area through the target area identification unit 130, and receives information about the target areas or objects in the target area from the ITS by using the communication unit 100.

The congestion degree acquisition unit 140 is a component that acquires the degree of congestion of the target area based on the characteristics of the objects in the target area and the characteristics of the target area itself.

Specifically, the congestion degree acquisition unit 140 acquires a degree of congestion of the target area based on type of objects in the target area, movement of the objects, distance between objects, number of objects, number of predicted objects, and speed limits in a target area. The congestion degree acquisition unit 140 may further acquire the degree of congestion of the target area based on the road width in the target area, the type of the vehicle, the traffic volume of the vehicle, and the like.

In accordance with an embodiment of the present disclosure, the congestion degree acquisition unit 140 may directly calculate a degree of congestion, or may acquire the calculated degree of congestion from an external device such as a server, a terminal, or the like through the communication unit 100. Specifically, the congestion degree acquisition unit 140 may acquire a degree of congestion by receiving the calculated degree of congestion, based on type of objects in the target area, movement of the objects, distance between objects, number of objects, predicted number of objects, and speed limits in a target area, from the external device.

In the following, a description will be given with reference to an embodiment in which the congestion degree acquisition unit 140 directly calculates the degree of congestion.

In accordance with an embodiment of the present disclosure, the congestion degree acquisition unit 140 identifies objects in the target area as pedestrians or PMDs, and calculates the degree of congestion based on the difference between the number of the pedestrians and the numbers of the PMDs. The congestion degree acquisition unit 140 may calculate the degree of congestion to be lower when the difference between the number of the pedestrians and the number of the PMDs is large, and calculate the degree of congestion to be higher when the difference is small. That is, if there are equal number of pedestrians and PMDs, it is determined that traffic in the target area is high.

In accordance with an embodiment of the present disclosure, the congestion degree acquisition unit 140 calculates distance between the PMD and the objects based on movement of the objects, and calculates the degree of congestion based on the distance between the PMD and the objects. The congestion degree acquisition unit 140 may calculate a higher degree of congestion as the distance between the PMD and the objects is close, and calculate a lower level of congestion when the distance is far. The congestion degree acquisition unit 140 may calculate the distance between the PMD and the objects for each of the objects, and may calculate the sum of the distances. At this time, the degree of congestion may be calculated according to each distance or the summed distance. In addition, the congestion degree acquisition unit 140 may calculate a degree of congestion according to a distance between the center position of the target area and the PMD. The congestion degree acquisition unit 140 may calculate the degree of congestion according to the distance between the center position of the objects and the PMD.

In accordance with an embodiment of the present disclosure, the congestion degree acquisition unit 140 calculates the degree of congestion based on the moving direction of objects in the target area. The congestion degree acquisition unit 140 calculates the degree of congestion to be higher as the objects move in a direction perpendicular, or nearly perpendicular, to the expected route, and calculates the degree of congestion lower as the objects move in a direction horizontal, or nearly horizontal, to the expected route. Directions nearly vertical and nearly horizontal may be referenced at an angle relative to the expected route. The congestion degree acquisition unit 140 may calculate an angle difference between the expected route and a movement direction for each of the objects, and may calculate a sum of the angle differences. Alternatively, the congestion degree acquisition unit 140 may acquire a sum of movement vectors or velocity vectors of objects, and calculate a degree of congestion with the sum of the vectors.

In accordance with an embodiment of the present disclosure, the congestion degree acquisition unit 140 calculates a higher degree of congestion as the distance between objects is close. Conversely, lower degree of congestion is calculated when the distance between the objects is far. That is, when the distance between the objects in the target area is far, density of the objects is low and it is determined that traffic is low.

In accordance with an embodiment of the present disclosure, the congestion degree acquisition unit 140 calculates a higher degree of congestion as the speed limit of the target area is lower. Specifically, in areas as a children protection zone, a school zone, an elderly protection zone and a disabled protection zone.

In accordance with an embodiment of the present disclosure, the congestion degree acquisition unit 140 calculates higher degree of congestion when there are higher number of objects in the target area.

In accordance with an embodiment of the present disclosure, the congestion degree acquisition unit 140 identifies a surrounding area of the target area, predicts a change in the number of objects in the target area based on the number and movement of the objects in a surrounding area, and calculates a degree of congestion based on the change of the predicted number of object in the target area. This is for the congestion degree acquisition unit 140 to calculate a higher degree of congestion when objects in the surrounding area are expected to move to the target area.

The control unit 150 controls the speed of the PMD according to the acquired degree of congestion.

The control unit 150 lowers the speed of the PMD when the degree of congestion of the target area is high. The control unit 150 may maintain or increase the speed of the PMD when the degree of congestion of the target area is low. The control unit 150 may control the deceleration rate differently depending on the degree of congestion. The control unit 150 can increase deceleration when the degree of congestion is higher. In addition, the control unit 150 can limit the speed of the PMD, and can raise the speed limit of the personal mobility device when the degree of congestion of the target area is low. Thus, the user can control the speed of the PMD in a wide range.

In addition, the control unit 150 can control the direction of the PMD according to the degree of congestion. For example, when the degree of congestion of the target area is high, the control unit 150 can control the direction of the PMD so that the device does not pass the target area.

The control device 10 identifies a target area according to an expected route of the PMD, calculates the degree of congestion in consideration of various characteristics of objects in the target area, and controls the PMD, so that it is possible to prevent collision and maximize operation efficiency with safety.

In accordance with an embodiment of the present disclosure, the control device 10 can be implemented as an external device of a PMD. In this case, the control device 10 may collect information about objects in the target area from the sensor unit 110, calculate the degree of congestion, and send command to the PMD. Speed and direction of the PMD, receiving the control command, may be controlled, or the speed limit may be raised.

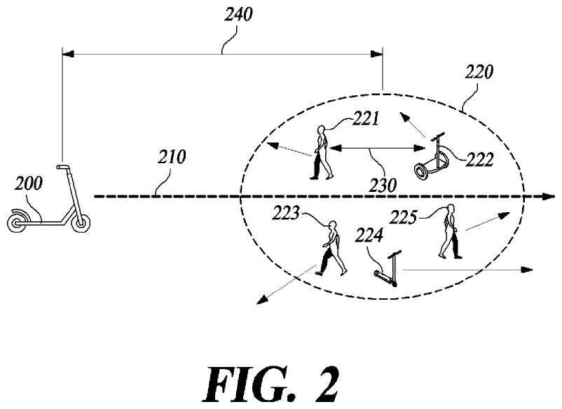

FIG. 2 is a diagram illustrating a control operation of a PMD in consideration of congestion in accordance with an embodiment of the present disclosure.

FIG. 2 shows PMD 200, expected route 210, target area 220, objects 221, 222, 223, 224, 225, first distance 230 between the objects, and second distance 240 between the personal mobility and objects. The unidirectional arrows in FIG. 2 mean either a movement vector or a velocity vector.

The control device 10 generates the expected route 210 of the PMD 200. The expected route 210 may be generated by GPS or driving information of the PMD 200.

The control device 10 identifies the target area 220 according to the expected route. In accordance with an embodiment of the present disclosure, the control device may identify the preset area or the area determined through object clustering as the target area 220 according to the expected route 210.

The control device 10 collects information about the objects 221, 222, 223, 224, 225 in the target area 220.

The control device 10 acquires the degree of congestion of the target area 220 based on the features of the objects 221, 222, 223, 224, 225 in the target area 220 and the feature of the target area 220.

In accordance with an embodiment of the present disclosure, the control device 10 acquires the degree of congestion of the target area 220 based on type of objects in the target area 220, movement of the objects, distance between objects, number of objects, expected number of objects, and speed limit of the target area.

The control device 10 may acquire the degree of congestion based on the type of the objects 221, 222, 223, 224, 225 in the target area 220. In FIG. 2, there are two PMDs among the objects 221, 222, 223, 224, 225, and there are three pedestrians among the objects 221, 222, 223, 224, 225. The control device may divide the objects 221, 222, 223, 224, 225 into PMDs and pedestrians, and acquire the degree of congestion based on a difference between the number of the PMDs and the number of the pedestrians.

The control device 10 may acquire the degree of congestion based on movement of the objects 221, 222, 223, 224, 225 in the target area 220. In FIG. 2, objects 221, 222, 223, 224, 225 have respective positions, directions and speeds of movement. The control device may calculate a second distance 240, which is a distance between the objects 221, 222, 223, 224, 225 and the PMD, and acquire the degree of congestion based on the second distance 240. The second distance 240 may be respective distances between the PMD 200 and the objects 221, 222, 223, 224, 225, the sum of the respective distances, or may be either the center of the objects 211, 222, 232, 224 or 225, or the target area 220.

Further, the control device 10 may acquire the degree of congestion in accordance with moving directions of the objects 221, 222, 223, 224, 225. The control device may acquire the degree of congestion based on the angle at which the movement vector or velocity vector of the objects 221, 222, 223, 224, 225 makes with the expected route 210. For example, a higher degree of congestion would be calculated when the movement vector or velocity vector of objects 221, 222, 223, 224, 225 is perpendicular, or nearly perpendicular, to the expected route. This is because there is a high probability that the objects 221, 222, 223, 224, 225 collide with the PMD 200 or interfere with driving.

The control device 10 may acquire the degree of congestion based on the first distance 230, which is a distance between objects in the target area 220. The control device may calculate a higher degree of congestion for each object as the first distance 230 is shorter.

The control device 10 may acquire the degree of congestion based on the speed limit of the target area 220, and may calculate a higher degree of congestion as the speed limit is lower.

The control device 10 may calculate a higher degree of congestion as the number of objects 221, 222, 223, 224, 225 in the target area 220 is greater.

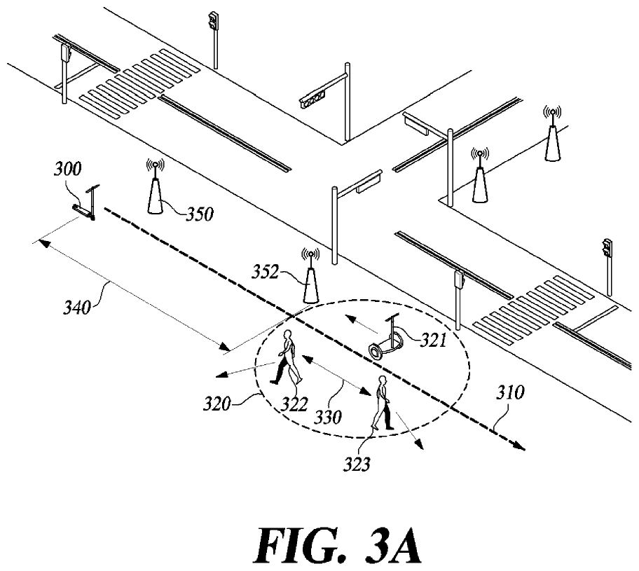

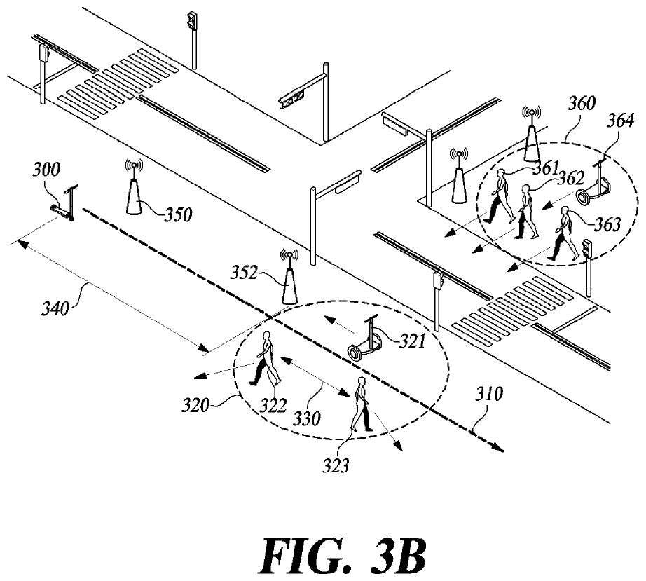

The control device 10 may acquire the degree of congestion of the target area 220 based on objects in the surrounding area in addition to the objects 221, 222, 223, 224, 225 in the target area 220. Detailed description will come with FIG. 3B.

FIGS. 3A and 3B are diagrams illustrating a control operation of a PMD in consideration of the degree of congestion in accordance with an embodiment of the disclosure.

FIG. 3A shows PMD 300, expected route 310, target area 320, objects 321, 322, 323, first distance 330 between objects, second distance 340 between the PMD 300 and the objects, and road side units 350, 352.

FIG. 3B further shows surrounding area 360 and surrounding area objects 361, 362, 363, 364.

The control device 10 may acquire the degree of congestion of the target area 320 by further considering the surrounding area 360 of the target area 320.

The control device 10 identifies a target area 320 along an expected route 310 of the PMD 300 and identifies a surrounding area 360 of the target area 320. The control device predicts change in the number of objects 321, 322, 323 in the target area 320 based on the number and movement of surrounding area objects 361, 362, 363, 364. The control device 10 acquires the degree of congestion based on a change in the number of predicted objects in the target area 320. For example, when it is determined that the surrounding area objects 361, 362, 363, and 364 move towards the target area 320, the control device may determine that the number of objects in the target area 320 will increased, and may calculate a higher degree of congestion in the target area 320. Further, the control device 10 may predict a change in objects in the target area 320 in consideration of movement data of an object between the target area 320 and the surrounding area 360 for each time zone.

By further considering the surrounding area 360, the control device 10 can accurately calculate the degree of congestion and improve the safety and the mobility of the PMD 300.

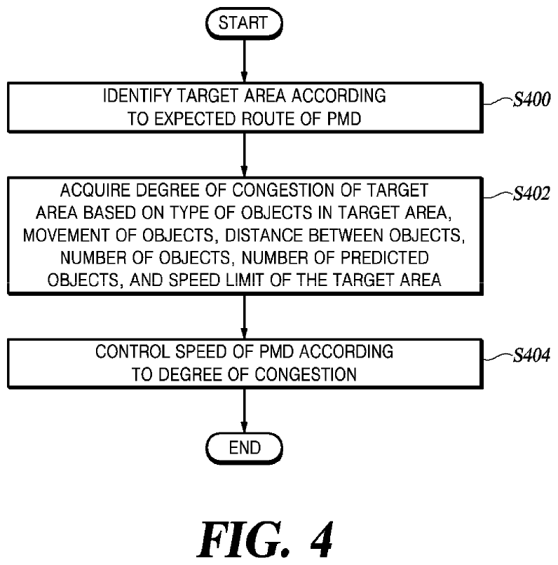

FIG. 4 is a flowchart illustrating a control process of the PMD in accordance with an embodiment of the present disclosure.

Referring to FIG. 4, the control device 10 identifies the target area according to the expected route of the PMD at S400.

In accordance with an embodiment of the present disclosure, the control device 10 identifies a preset area or an area determined through object clustering, according to an expected route of the PMD.

The control device 10 acquires the degree of congestion of the target area based on type of objects in the target area, movement of the objects, distance between objects, number of the objects, number of predicted objects, and speed limit of the target area at S402.

In accordance with an embodiment of the present disclosure, the control device identifies the type of objects in the target area as pedestrians or a PMDs, and acquires the degree of congestion based on the difference between the number of the pedestrians and the numbers of the PMDs.

In accordance with an embodiment of the present disclosure, the control device 10 acquires the distance between the PMD and the objects based on movement of the objects, and acquires the degree of congestion based on the distance between the PMD and the objects.

In accordance with an embodiment of the present disclosure, the control device acquires the degree of congestion based on an angle difference between the expected route and a movement direction for each of the objects.

In accordance with an embodiment of the present disclosure, the control device 10 calculates a higher degree of congestion as the distance between objects is closer. Conversely, the greater the distance between control device objects, the lower the degree of congestion.

In accordance with an embodiment of the present disclosure, the control device 10 calculates the degree of congestion higher as the speed limit of the target area is lower.

In accordance with an embodiment of the present disclosure, the control device 10 calculates higher degree of congestion with higher number of objects in the target area.

In accordance with an embodiment of the present disclosure, the control device 10 identifies a surrounding area of a target area, predicts a change in the number of objects in the target area based on the number of the objects and movement of the object in the surrounding area, and acquires a degree of congestion based on the change of the predicted number of objects in the target region.

The control device 10 controls the speed or the speed limit of the PMD in accordance with the degree of congestion at S404. The control device can further control the direction of the PMD.

Speed or speed limit for the PMD can be controlled differently depending on the type of the PMD, the ratio of pedestrians, and the number of elders, children, disabled and the like. The speed or speed limit for each PMD can be controlled differently even if the PMDs are in the same target area.

For example, on roads with large vehicles or on sidewalks with a large number of pedestrians or elders, the speed of the PMD can be further decelerated or the speed limit can be set lower. As another example, it is possible to control the speed of the large vehicle in the target area to be lower than the speed of the electric kickboard.

In accordance with an embodiment of the present disclosure, when the PMD moves out of the target area, the speed control or the speed limit setting of the PMD can be stopped. The speed control or the speed limit setting may be stopped as soon as the PMD leaves the target area, or may be stopped when after certain time or a certain distance has passed.

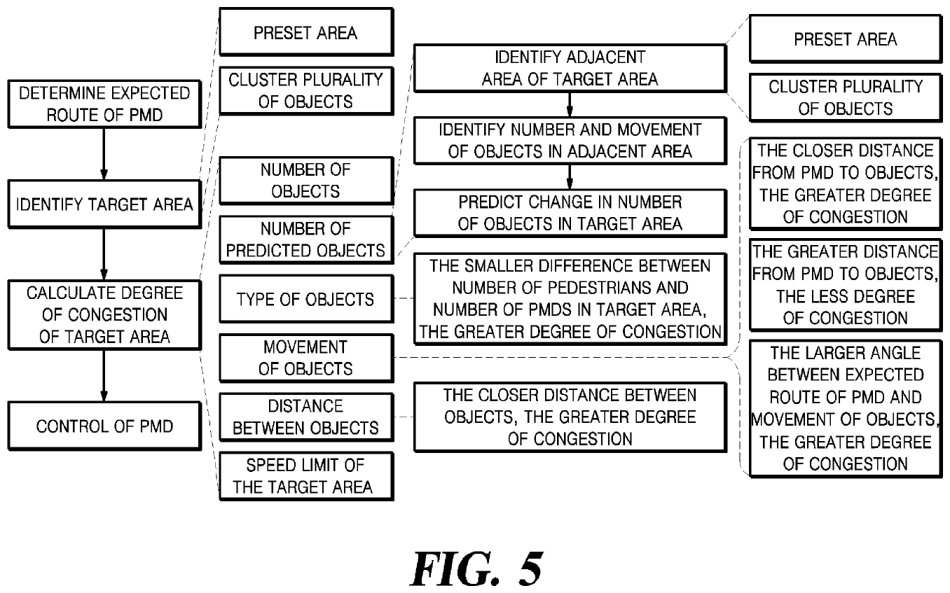

FIG. 5 is a flowchart illustrating a specific control procedure of the PMD in accordance with an embodiment of the present disclosure.

Although it is described in FIG. 4 that operations S400 to S404 are sequentially executed, this merely illustrates the technical idea of an embodiment of the present disclosure. In other words, those having ordinary skill in the technical field to which an embodiment of the present disclosure belongs may change the order described in FIG. 4 within a range that does not deviate from the essential characteristics of an embodiment of the present disclosure. Alternatively, those having ordinary skill in the technical field may apply various modifications and variations to execute one or more of the operations S400 to S404 in parallel. Thus, FIG. 4 is not limited to a time-series order. The above modifications and variations should be within the scope of the present disclosure.

Meanwhile, the operations illustrated in FIG. 4, as well as the apparatus including the various units identified above and in FIG. 1, can be implemented as computer-readable codes on a computer-readable recording medium. The computer readable recording medium may include all kinds of recording apparatuses in which data that may be read by a computer system is stored. In other words, the computer-readable recording medium may be a non-transitory medium, such as a read-only memory (ROM), a random-access memory (RAM), a compact disc (CD)-ROM, a magnetic tape, a floppy disk, and an optical data storage device. The computer readable recording medium may further include a transitory medium such as a carrier wave (for example, transmission over the Internet) and a data transmission medium. In addition, the computer readable recording media may be distributed in computer systems connected to each other through a network such that the computer readable codes may be stored and executed in the computer readable recording media in a distributed scheme.

In addition, components of the present disclosure may use an integrated circuit structure, such as a memory, a processor, a logic circuit, a look-up table, and the like. These integrated circuit structures execute each of the functions described herein through the control of one or more microprocessors or other control devices. In addition, components of the present disclosure may be specifically implemented by a program or a portion of a code that includes one or more executable instructions for performing a specific logical function and is executed by one or more microprocessors or other control devices. In addition, components of the present disclosure may include or be implemented as a Central Processing Unit (CPU), a microprocessor, and the like that performs respective functions. In addition, components of the present disclosure may store instructions executed by one or more processors in one or more memories.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present embodiments is not limited by the illustrations. Accordingly, those having ordinary skill should understand the scope of the present disclosure should not be limited by the above explicitly described embodiments but by the claims and equivalents thereof.

As described above, according to the embodiment of the present disclosure, it is possible to prevent a PMD from collision by controlling the speed of the PMD in consideration of the degree of congestion according to the expected route of the PMD.

As described above, according to another embodiment of the present disclosure, it is possible to maximize the operation efficiency while promoting the safety of a PMD by identifying the target area according to the predicted route of the PMD and calculating the congestion level in consideration of various characteristics of objects in the target area, and controlling the PMD.

1. A control method of a personal mobility device (PMD) depending on congestion, comprising:
identifying a target area according to an expected route of the PMD;
acquiring a degree of congestion of the target area based on a plurality of objects using at least one of: a type of each of the objects, a movement of each of the objects, a distance between objects, a number of objects that is expected, and a speed limit of the target area; and
controlling speed of the PMD according to the degree of congestion.

2. The method of claim 1, wherein identifying the target area includes identifying a preset area or an area determined through an object clustering according to an expected route of the PMD.

3. The method of claim 1, wherein acquiring the degree of congestion includes:
identifying the type of each of the objects in the target area as a pedestrian or a PMD; and
acquiring the degree of congestion based on difference between the number of pedestrians and the number of PMDs.

4. The method of claim 1, wherein acquiring the degree of congestion includes:
calculating a distance between the PMD and the plurality of objects based on movement of each of the objects; and
calculating the degree of congestion based on the distance between the PMD and each of the objects.

5. The method of claim 1, wherein acquiring the degree of congestion includes calculating the degree of congestion based on angle difference between the expected route and a movement direction for each of the objects.

6. The method of claim 1, wherein acquiring the degree of congestion includes calculating the degree of congestion to be higher as the distance between each of the objects is shorter.

7. The method of claim 1, wherein acquiring the degree of congestion includes calculating the degree of congestion to be higher as the speed limit of the target area is lower.

8. The method of claim 1, wherein acquiring the degree of congestion includes calculating the degree of congestion to be higher as the number of objects in the target area is greater.

9. The method of claim 1, wherein acquiring the degree of congestion includes:
identifying a surrounding area of the target area;
predicting a change in the number of objects in the target area, based on the number of the plurality of objects and the movement of the plurality of objects in the surrounding area; and
calculating the degree of congestion based on the change in the number of the objects within the target area.

10. The method of claim 1, wherein acquiring of the degree of congestion includes receiving the degree of congestion calculated by an external device, based on at least one of the type of each of the objects in the target area, the movement of each of the objects, the distance between objects, the number of objects, the predicted number of objects, and the speed limit of the target area.

11. A control device for a personal mobility device (PMD) performing control depending on congestion, comprising:
a target area identification unit that identifies a target area according to an expected route of the PMD;
a congestion degree acquisition unit that acquires a degree of congestion of the target area based on a plurality of objects, using at least one of: a type of each of the objects in the target area, a movement of each of the objects, a distance between objects, a number of objects that is expected, and a speed limit of the target area; and
a control unit that controls the speed of the PMD according the degree of congestion.

12. The apparatus of claim 11, wherein the target area identification unit identifies a preset area or identifies an area determined through an object clustering according to an expected route of the PMD.

13. The apparatus of claim 11, wherein the congestion degree acquisition unit identifies the type of objects in the target area as a pedestrian or a PMD, and calculates the degree of congestion based on a difference between the number of pedestrians and the number the PMDs.

14. The apparatus of claim 11, wherein the congestion degree acquisition unit calculates a distance between the PMD and the plurality of objects based on a movement of each of the objects, and calculates the degree of congestion based on the distances between the PMD and each of the objects.

15. The apparatus of claim 11, wherein the congestion degree acquisition unit calculates the degree of congestion based on an angle difference between the expected route and a movement direction for each of the objects.

16. The apparatus of claim 11, wherein the congestion degree acquisition unit calculates the degree of congestion to be higher as the distance between each of the objects is shorter.

17. The apparatus of claim 11, wherein the congestion degree acquisition unit calculates the degree of congestion to be higher as the speed limit of the target area is lower.

18. The apparatus of claim 11, wherein the congestion degree acquisition unit calculates the degree of congestion to be higher as the number of objects in the target area is greater.

19. The apparatus of claim 11, wherein the congestion degree acquisition unit identifies a surrounding area of the target area, predicts a change in the number of objects in the target area based on the number of the plurality of objects and movement of the plurality of objects within the surrounding area, and calculates the degree of congestion based on a change of the predicted number of objects in the target area.

20. The apparatus of claim 11, wherein the congestion degree acquisition unit receives the degree of congestion calculated by the external device based on at least one of a type of objects in the target area, a movement of the objects, a distance between objects, the number of objects, and a speed limit of the target area.
